(19) United States
(12) Patent Application Publication
(10) Pub. No.: US 2012/0125295 A1
(43) Pub. Date: May 24, 2012

(54) ENGINE CONTROLLER

(75) Inventors: Takashi SENDA, Niwa-gun (JP); Hironori ASA, Okazaki-city (JP); Hiroaki TAKEISHI, Obu-city (JP)

(73) Assignee: DENSO CORPORATION, Kariya-city (JP)

(21) Appl. No.: 13/298,551

(22) Filed: Nov. 17, 2011

(30) Foreign Application Priority Data
Nov. 19, 2010 (JP) 2010-259372

(51) Int. Cl. F02M 51/00

(52) U.S. Cl. 123/478

(57) ABSTRACT

An ECU detects a shaft torque in a specified torque detection range defined for each cylinder. The shaft torque is generated due to a combustion of the fuel and is applied to a crankshaft of the engine. The ECU computes a crank angle position as an actual peak position at which a combustion torque is peak. The ECU stores a previously determined maximum torque position which corresponds to a crank angle position at which a combustion torque becomes peak. Based on the actual peak position and the previously stored maximum torque position, an igniter controls an ignition timing.

### CROSS-REFERENCE TO RELATED APPLICATION

This application is based on Japanese Patent Application No. 2010-259372 filed on Nov. 19, 2010, the disclosure of which is incorporated herein by reference.

### FIELD OF THE INVENTION

The present invention relates to an engine controller which controls an ignition timing based on a shaft torque applied to a crankshaft along with a combustion in a cylinder of an engine.

### BACKGROUND OF THE INVENTION

JP-52-39038A (Patent Document 1) and JP-U-1-21181B (Patent Document 2) show that a shaft torque applied to a crankshaft along with a combustion in a cylinder is detected by means of a torque sensor. Based on this detected torque, an ignition timing of an engine is controlled so that the ignition timing agrees with a minimum advance for best torque (MBT) at which the shaft torque becomes maximum.

In view that the shaft torque is decreased when the ignition timing deviates from the MBT, in the Patent Document 1, the ignition timing is periodically varied at a top dead center in a compression stroke, whereby it is determined whether the ignition timing is advanced or retarded based on a variation in the shaft torque. After the direction of the ignition timing (advanced direction or retarded direction) is defined, a variation amount of the ignition timing is constant.

In the Patent Document 2, a basic ignition timing is corrected based on a correction control value. This correction control value is learned and corrected so that the shaft torque becomes maximum value. A correction amount of the correction control value depends on a variation in shaft torque when the ignition timing is varied.

However, in the above Patent Documents 1 and 2, it is necessary to compulsorily vary the ignition timing in order to obtain the MBT, which may result in a complicated control. Specifically, in the Patent Document 1, when obtaining the MBT, the variation amount of the ignition timing is always constant. In the Patent Document 2, when obtaining the MBT, the variation amount of the ignition timing is varied according to a variation in torque per unit advance angle. If the above variation amount of the ignition timing is too small, it will takes a long time until the shaft torque becomes maximum value. If the above variation amount of the ignition timing is too large, it is likely that the maximum torque point is not correctly detected.

### SUMMARY OF THE INVENTION

The present invention is made in view of the above matters, and it is an object of the present invention to provide an engine controller which is able to correctly adjust an ignition timing to an optimum value promptly when an ignition timing control is executed based on a shaft torque.

According to the present invention, a controller is applied to an internal combustion engine having a fuel injector (15) injecting a fuel and an igniter (17) igniting the fuel with respect to each cylinder. The controller includes: a torque detecting portion (33) detecting a shaft torque in a specified torque detection range defined for each cylinder, the shaft torque being generated due to a combustion of the fuel injected by the fuel injector (15); a peak position computing portion (F1, F11) computing a crank angle position as an actual peak position at which a combustion torque becomes peak, based on the shaft torque detected by the torque detecting portion; a position-storing portion (M9) storing a previously determined maximum torque position which corresponds to a crank angle position at which a combustion torque becomes peak; and an ignition timing control portion (M11) controlling an ignition timing based on the actual peak position computed by the peak position computing portion and the maximum torque position stored in the position-storing portion (M9).

The maximum torque position can be obtained by reading out from the memory without compulsorily varying the ignition timing. Thus, the ignition timing can be correctly promptly controlled to the optimum value without executing a complicated control.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing an engine control system;

FIG. 2 is a time chart showing a variation in instantaneous value of a combustion torque;

FIG. 3 is a graph showing a relationship between an average of the combustion torque and a crankshaft position;

FIG. 4 is a time chart showing a relationship between an inertia torque and an engine speed;

FIG. 5 is a graph showing a relationship between an average of the combustion torque and a crankshaft position;

FIG. 6 is a block chart showing a configuration of an ECU;

FIG. 7 is a graph showing a map for establishing a correction quantity;

FIG. 8 is a flowchart showing a processing of an ignition timing control; and

FIG. 9 is a block chart showing a configuration of an ECU according to other embodiment.

### DETAILED DESCRIPTION OF EMBODIMENTS

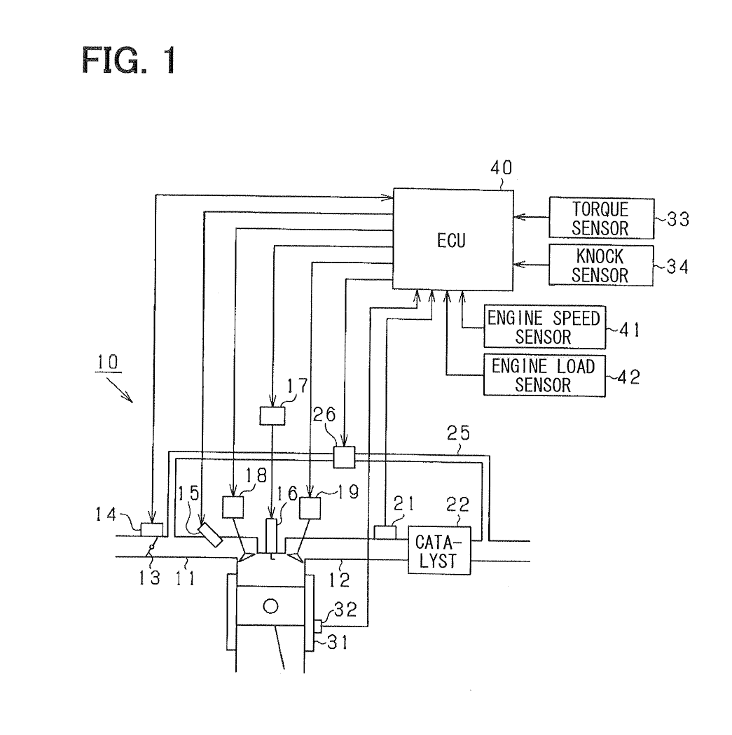

Referring to drawings, an embodiment of the present invention will be described, in which the present invention is applied to a multi-cylinder gasoline engine of a spark ignition type. FIG. 1 is a schematic chart showing an engine control system according to an embodiment of the present invention.

An engine 10 is provided with an intake pipe 11 and an exhaust pipe 12. A throttle valve 13 is provided in the intake pipe 11. The throttle valve 13 is driven by an electric throttle actuator 14, such as an electric motor. The throttle actuator 14 is provided with a throttle position sensor (not shown) which detects a position of the throttle valve 13 (throttle opening degree).

The engine 10 is provided with a fuel injector 15, an igniter 17, a spark plug 16, an intake valve timing controller 18 and an exhaust valve timing controller 19. In the present embodiment, the engine 10 is an intake port injection engine in which the injector 15 is arranged at a vicinity of an intake port. The engine 10 can be a direct injection engine in which the injector 15 is mounted to a cylinder head of each cylinder.

The intake valve timing controller 18 and the exhaust valve timing controller 19 respectively adjust an advance amount of an intake camshaft and an exhaust camshaft relative to a crankshaft of the engine 10. The intake valve timing controller 18 advances or retards a valve timing of an intake valve, and the exhaust valve timing controller 19 advances or retards a valve timing of an exhaust valve. By controlling the valve timing of each valve, a valve overlap period in which both valves are opened can be adjusted. It should be noted that only one of the valve timing controllers 18, 19 may be provided as long as a valve opening timing can be varied in varying the valve overlap period.

An oxygen concentration sensor 21 detecting an oxygen concentration in exhaust gas is provided to the exhaust pipe 12. A three-way catalyst 22 which purifies the exhaust gas is provided downstream of the oxygen concentration sensor 21.

Further, the engine 10 is provided with a torque sensor 33 which detects a shaft torque applied to a crankshaft. Specifically, the torque sensor 33 is arranged at an output end of the crankshaft. The torque sensor 33 is a contact-type or non-contact-type sensor which detects strain angle of the crankshaft.

The engine 10 is provided with an exhaust gas recirculation system (EGR system) for recirculating a part of exhaust gas into the intake system. An EGR pipe 25 connects the intake pipe 11 and the exhaust pipe 12. The EGR pipe 25 is provided with an electromagnetic EGR valve 26 which adjusts an EGR gas quantity flowing through the EGR pipe 25.

This control system is provided with an electronic control unit (ECU) 40 which executes various controls of the engine 10. The ECU 40 is comprised of a microcomputer including a CPU, a ROM, and a RAM. The ECU 40 executes control programs stored in the ROM to perform various controls according to the engine driving condition. The control system is provided with an engine driving condition detector, such as engine speed sensor 41, an engine load sensor 42, an engine coolant temperature sensor 32, and a knock sensor 34. The outputs of these sensors 41, 42, 32, 34, the oxygen sensor 21, and the torque sensor 33 are transmitted to the ECU 40.

The ECU 40 executes a fuel injection control, an ignition timing control, a valve timing control, and an intake air control based on the output signals from the above sensors. Each control is executed based on an adapted data so that a maximum efficiency (highest fuel economy) of the engine 10 is obtained.

For example, with respect to the ignition timing control, an energization period of a primary coil of the igniter 17 is adjusted based on the current engine speed and engine torque so that the ignition timing corresponds to the MBT.

The ignition timing is adjusted based on the shaft torque detected by the torque sensor 33. Especially, according to the present embodiment, in view that a peak value of the combustion torque in each cylinder appears at a specified constant rotational angle of the engine without respect to an engine driving condition, the ignition timing is controlled in such a manner as to agree with the MBT. The ignition timing control will be described in detail hereinafter.

FIG. 2 is a time chart showing a variation in instantaneous value of a combustion torque Trc. In this time chart, it is assumed that the engine is stably driven. Further, the ignition is conducted in a first cylinder (#1), a third cylinder (#3), a fourth cylinder (#4) and a second cylinder (#2) in this series.

As shown in FIG. 2, the instantaneous value of the combustion torque Trc, which is referred to as the combustion torque Trc hereinafter, varies at a combustion cycle (180° C.A in a four-cylinder engine). Specifically, along with a combustion, the combustion torque Trc increase and positive peak values P1-P4 appear. In a case that the engine 10 is stably driven, each of the peak values P1-P4 appears at substantially the same crank angle in a combustion cycle of a single cylinder. It should be noted that the combustion cycle of the single cylinder corresponds to a torque detection range which defined for each cylinder.

If the ignition timing is retarded relative to the MBT, the appearance timing of the peak values P1-P4 are also retarded and each peak value its self becomes smaller relative to a case where the ignition timing is established at the MBT. Also, an average of the combustion torque Trc becomes smaller.

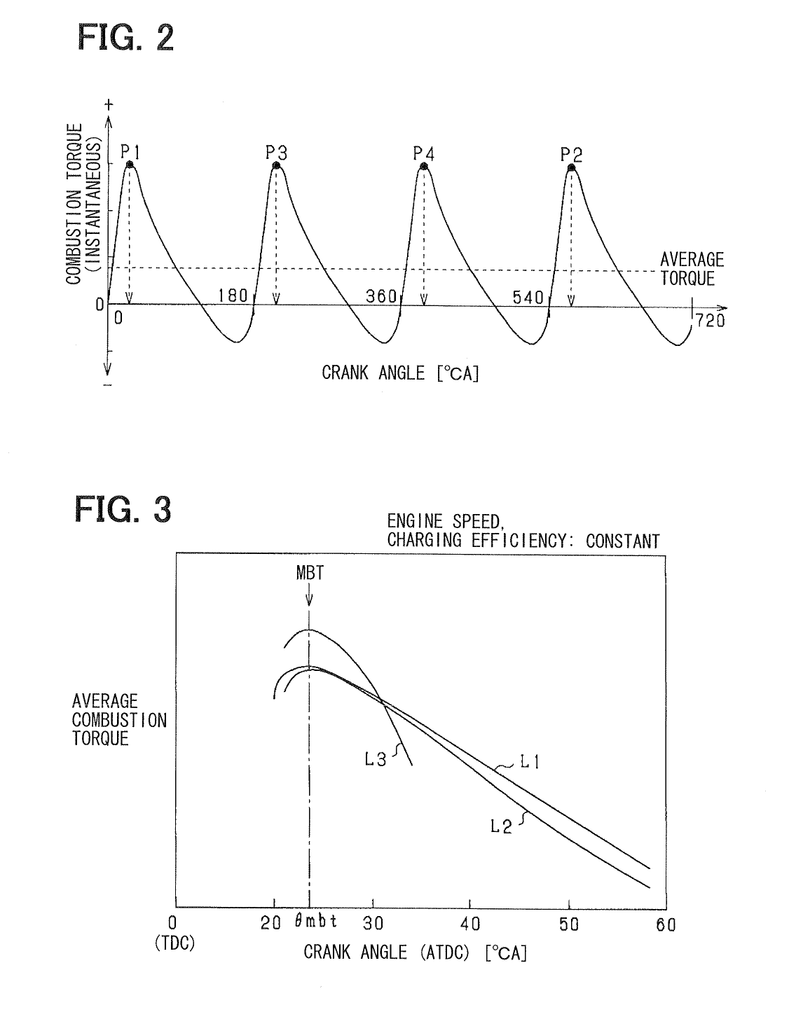

FIG. 3 shows a relationship between the average of the combustion torque Trc and the crank angle position of the peak value. In FIG. 3, such a relationship is indicated with respect to three engine driving conditions L1-L3 in which the intake valve timing and an EGR quantity are different from each other. Specifically, in a first engine driving condition L1, the intake valve timing is set as θv1 and the EGR quantity is set zero. In a second driving condition L2, the intake valve timing is set as θv2 which is advanced than θv1 and the EGR quantity is set zero. In a third driving condition L3, the intake valve timing is set as θv1 and the EGR quantity is set as Q1. Besides, the engine speed and the charging efficiency are set constant.

In any of driving conditions L1-L3, when the crank angle position of each peak value is a specified crank angle position, the average of the combustion torque Trc is maximum value. Specifically, in FIG. 3, the position of each peak value is around 23° C.A, the average of the combustion torque Trc is maximum. Thus, it is apparent that the average of the combustion torque Trc becomes peak at a crank angle position θmbt in a case that the ignition timing is set to the MBT. It should be noted that the crank angle position of which the peak values P1-P4 appear almost agrees with the crank angle position θmbt.

According to the present embodiment, the crank angle position at which the combustion torque Trc becomes peak is previously defined for a case that the ignition timing is set to the MBT. This previously defined crank angle position is stored in a ROM as a MBT-position θmbt. When the engine is running, the torque sensor 33 detects the shaft torque with respect to each cylinder during a power stoke. Based on the detected shaft torque, the crank angle position at which the combustion torque Trc becomes peak is computed as an actual peak position θp. Then, the stored MBT-position θmbt and the computed actual peak position θp are compared with each other. Based on the comparison result, the ignition timing of the engine 100 is controlled.

In a case that the shaft torque is detected by the torque sensor 33, the detected shaft torque receives some inertia torque from a reciprocating member, such as a piston in a cylinder. The inertia torque fluctuates due to a variation in engine speed and crank angle. Especially, the inertia torque fluctuates due to a variation in engine speed.

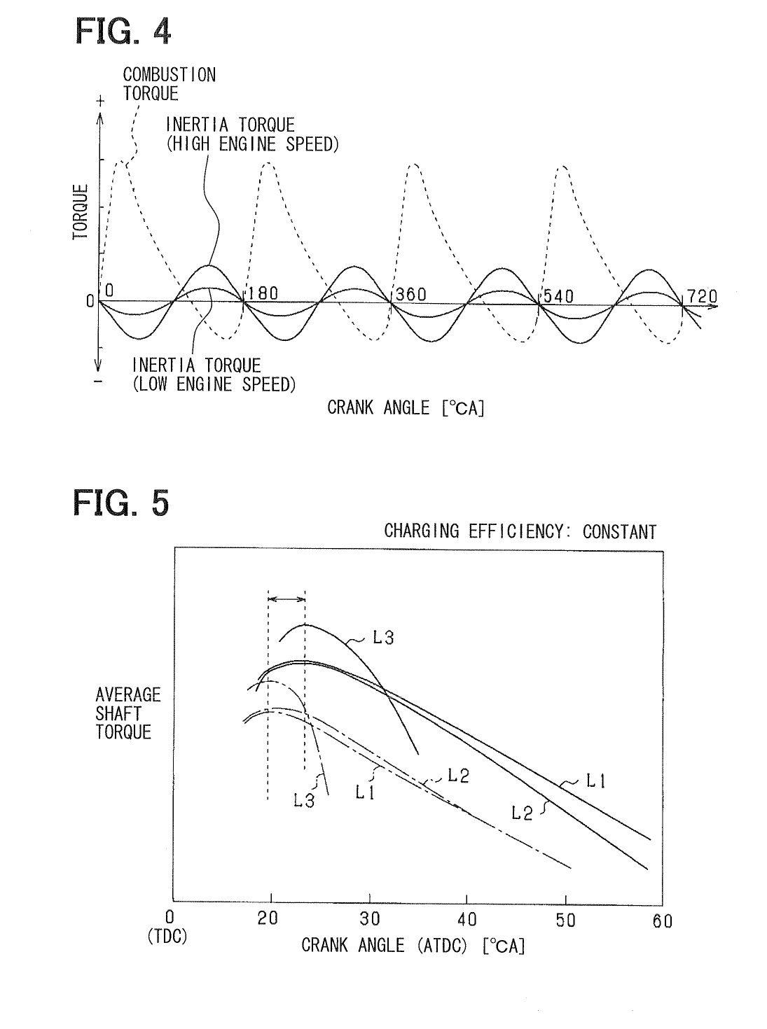

FIG. 4 is a time chart showing a relationship between an engine speed and the inertia torque. As shown in FIG. 4, the inertia torque varies with a peak while a combustion cycle with respect to a single cylinder is defined as one cycle. A variation range (amplitude) of the inertia torque is different between a case of high engine speed and a case of low engine speed. As the engine speed becomes higher, the amplitude of the inertia torque becomes larger. The peak position of the inertia torque is different from the peak position of the combustion torque. In this case, it is conceivable that the crank position at which the shaft torque becomes peak varies according to the variation range of the inertia torque, so that a deviation is generated between the peak position of the combustion torque and the peak position of the detected shaft torque.

FIG. 5 shows a relationship between a peak position of the instantaneous shaft torque Trs and an average torque in a case that the engine speed is varied. In FIG. 5, L1-L3 indicates three engine driving conditions in the same manner as FIG. 3. The solid lines indicate a case where the engine speed is relatively low and the long dashed short dashed lines indicate a case where the engine speed is relatively high. According to FIG. 5, it is apparent that the crank angle position where an average of the shaft torque Trs becomes maximum value is different between the case where the engine speed is low and a case where the engine speed is high.

According to the present embodiment, the inertia torque is computed based on the engine driving condition and the actual peak position θp is computed based on the computed inertia torque and the detected shaft torque Trs. Specifically, a crank angle position where the detected shaft torque Trs is peak is computed as a detected peak position θp1, and then this detected peak position θp1 is corrected by the inertia torque. The corrected peak position θp1 is defined as the actual peak position θp. Based on this actual peak position θp and the previously stored MBT-position θmbt, the ignition timing is controlled.

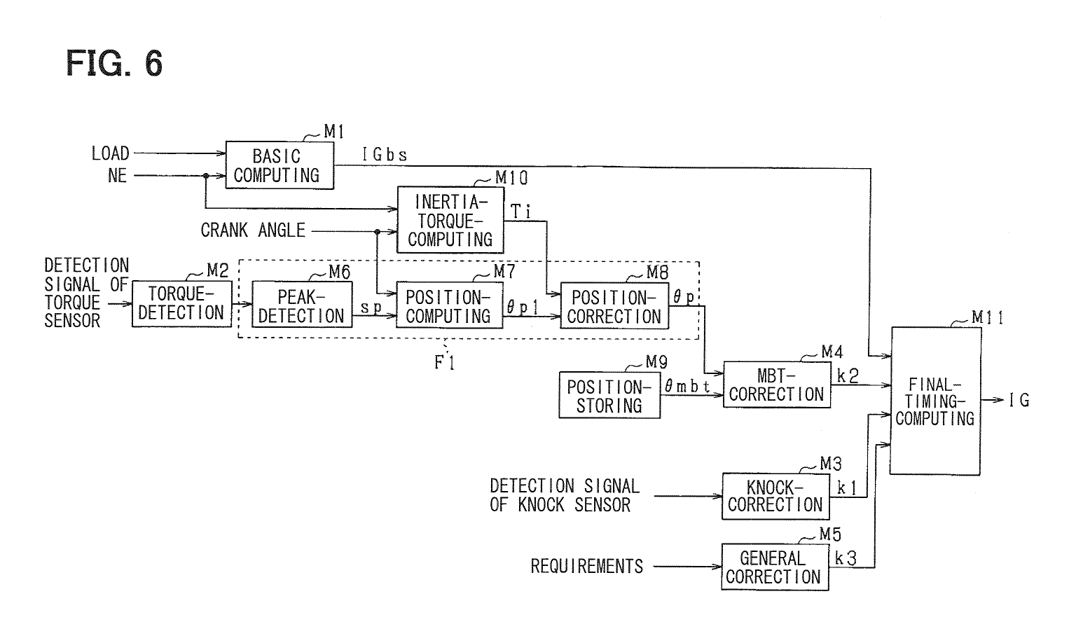

FIG. 6 is a block chart showing a configuration of the ECU 40. Referring to FIG. 6, an ignition timing control will be described hereinafter.

The ECU 40 has a basic computing portion M1 which computes a basic ignition timing. The basic computing portion M1 stores a map which indicates a relationship between the engine load, the engine speed NE and the basic ignition timing. According to this map, a basic ignition timing IGbs is computed.

Further, the ECU 40 has a knock-correction portion M3 which computes a knock-correction quantity k1 according to existence or nonexistence of a knocking, an MBT-correction portion M4 which computes an MBT-correction quantity k2 for operating the engine at optimum condition, and a general correction portion M5 which computes correction quantities k3 for various corrections. The knock-correction portion M3 receives a detection signal from a knock sensor 34 and computes the knock-correction quantity k1 The general correction portion M5 computes the correction quantities k3 when a various requirements, such as warming-up requirement and an idle speed control requirement, are generated.

The MBT-correction portion M4 computes a correction quantity of the ignition timing in order that the peak of the instantaneous value of the combustion torque Trc appears at the previously determined MBT-position θmbt.

Further, the ECU 40 has a torque-detection portion M2 which detects the shaft torque Trs, a peak-detection portion M6 which detects a peak of the detected shaft torque Trs, a position-computing portion M7 which computes a rotational position at which a torque peak appears, and a position-storing portion M9 which stores the previously determined MBT-position θmbt. The torque-detection portion M2 receives the detection signal from the torque sensor 33 and detects the shaft torque Trs. The peak-detection portion M6 detects a positive peak of the detected shaft torque Trs based on a derivative of the detected shaft torque Trs. Alternatively, the peak-detection portion M6 may detects the positive peak based on a difference between previous detected shaft torque Trs and current detected shaft torque Trs. This peak-detection portion M6 transmits a peak detection signal “sp” to the position-computing portion M7.

When the position-computing portion M7 receives the peak detection signal “sp”, the position-computing portion M7 stores the current crank angle position as the detected peak position θp1. Then, the portion M7 transmits the peak position θp1 to a position-correction portion M8. The crank angle is computed by the ECU 40 based on the detection signal of the engine speed sensor 41.

The position-correction portion M8 receives the peak position θp1 from the portion M7 and the inertia torque Ti which an inertia-torque-computing portion M10 computes. The portion M8 corrects the peak position θp1 according to the inertia torque Ti.

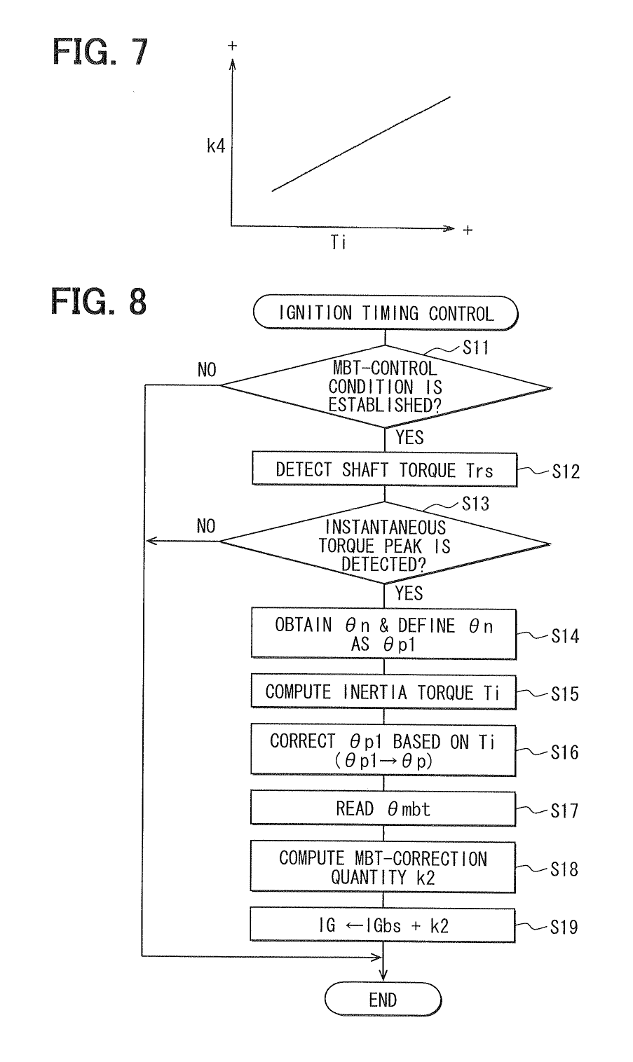

Specifically, the inertia-torque-computing portion M10 previously stores a map indicating a relationship between the engine speed NE, the crank angle and the inertia torque Ti. Based on this map, the portion M10 computes the inertia torque Ti. The position-correction portion M8 previously stores a map indicating a relationship between the inertia torque Ti and a position-correction quantity k4 to compute the position-correction quantity k4, which is shown in FIG. 7. The portion M8 corrects the peak position θp1 and stores the peak position θp1 as the actual peak position θp. As shown in FIG. 7, as the inertia torque Ti is larger, the position-correction quantity k4 is set larger.

The above portions M6, M7 and M8, which are enclosed by a dashed line F1 in FIG. 6, correspond to a peak position computing portion.

Referring back to FIG. 6, the MBT-correction portion M4 receives the actual peak position θp from the portion M8 and the MBT-position θmbt from the portion M9. Then, the MBT-correction portion M4 computes the MBT-correction quantity k2 according to a difference between the actual peak position θp and the MBT-position θmbt.

Furthermore, the ECU 40 has a final-timing-computing portion M11 which computes a final ignition timing IG based on the basic ignition timing IGbs and the above correction quantities k1-k3. The final-timing-computing portion M11 receives the basic ignition timing IGbs from the portion M1, the knock-correction quantity k1 from the portion M3, the MBT-correction quantity k2 from the portion M4 and the correction quantities k3 from the portion M5. The portion M11 corrects the basic ignition timing IGbs based on the above correction quantities k1-k3 and computes the final ignition timing IG. The final ignition timing IG is defined not to exceed a knock limit. The ECU 40 controls an energization period of the igniter 17 based on the final ignition timing IG.

Referring to a flowchart shown in FIG. 8, the processing of the ignition timing control will be described hereinafter. This processing is executed in a specified cycle by the ECU 40.

In step S11, the computer determines whether an MBT-control condition is established for controlling the ignition timing at the MBT. The MBT-control condition is established, for example, when no knocking is detected by the knock sensor 34, no requirement for warming-up catalyst is generated, or the engine is not idling. When the MBT-control condition is not established, no ignition timing correction is conducted to end the routine. When the answer is YES in step S11, the procedure proceeds to step S12.

In step S12, the instantaneous value of the shaft torque Trs is detected based on the detection value of the torque sensor 33. In step S13, the computer determines whether a peak of the instantaneous torque is detected. When the answer is YES in step S13, the procedure proceeds to step S14 in which the current crank angle position θn [° C.A] is obtained and this position θn is defined as the detected peak position θp1 [° C.A]. In step S15, the computer computes the inertia torque Ti based on the engine speed and the crank angle. In step S16, the detected peak position θp1 is corrected based on the computed inertia torque Ti and the corrected peak position is stored as the actual peak position θp [° C.A].

In step S17, the MBT-position θmbt is read out from the ROM. In step S18, the MBT-correction quantity k2 is computed. In the present embodiment, the MBT-correction quantity k2 is computed according to a difference between the actual peak position θp [° C.A] and the MBT-position θmbt [° C.A]. In a case that the actual peak position θp is retarded relative to the MBT-position θmbt, the MBT-correction quantity k2 is computed as an ignition timing advance quantity. In a case that the actual peak position θp is advanced relative to the MBT-position θmbt, the MBT-correction quantity k2 is computed as an ignition timing retard quantity. Then, in step S19, the final ignition timing is computed based on the basic ignition timing IGbs and the MBT-correction quantity k2.

According to the present embodiment, the MBT-correction quantity k2 is reflected in determining an ignition timing of a successive cylinder. For example, in a case that an ignition occurs in the first cylinder #1, the third cylinder #3, the fourth cylinder #4, and the second cylinder #2 in this series, the ignition timing of the third cylinder #3 is advanced based on the MBT-correction quantity k2 of the first cylinder #1. The ignition timing of the second cylinder #2 is advanced based on the MBT-correction quantity k2 of the fourth cylinder #4.

According to the present embodiment, following advantages can be obtained.

Since the MBT-position θmbt is previously stored in a memory and the ignition timing is controlled based on the MBT-position θmbt and the detected shaft torque Trs, the MBT can be obtained by reading out from the memory without compulsorily varying the ignition timing. Thus, the ignition timing can be correctly promptly controlled to the optimum value without executing a complicated control.

Since the actual peak position θp is obtained by correcting the detected peak position θp1 according to the inertia torque Ti, any influence of a torque due to an inertia quantity can be removed from the engine torque detected by the torque sensor 33. Thus, the crank angle position at which the combustion torque is peak can be computed without respect to an engine driving condition, whereby a controllability of the ignition timing can be enhanced.

Since the torque sensor 33 detects the shaft torque, the torque peak of each cylinder can be detected by means of only one torque sensor 33 in a system. Further, since the torque sensor 33 can directly detects the shaft torque, the engine torque can be detected with high accuracy.

When the MBT-control condition is established, the ignition timing correction is conducted based on the MBT-correction quantity k2. Thus, the ignition timing control for avoiding a knocking can be preferentially conducted. In a region where a knocking easily occurs, the ignition timing control is conducted at a trace knock ignition timing. In the other region, the ignition timing control is conducted at the MBT.

### Other Embodiment

The present invention is not limited to the embodiment described above, but may be performed, for example, in the following manner.

In the above embodiment, the MBT-correction quantity k2 is reflected on an ignition timing of a successive combustion cylinder. According to another embodiment, the MBT-correction quantity k2 may be reflected on an ignition timing of the same combustion cylinder after one combustion cycle.

The shaft torque may be detected based on a detection value of the engine speed sensor 41.

The shaft torque Trs is corrected based on the inertia torque Ti. When the corrected shaft torque Trs becomes peak, the current crank angle position may be defined as the actual peak position θp.

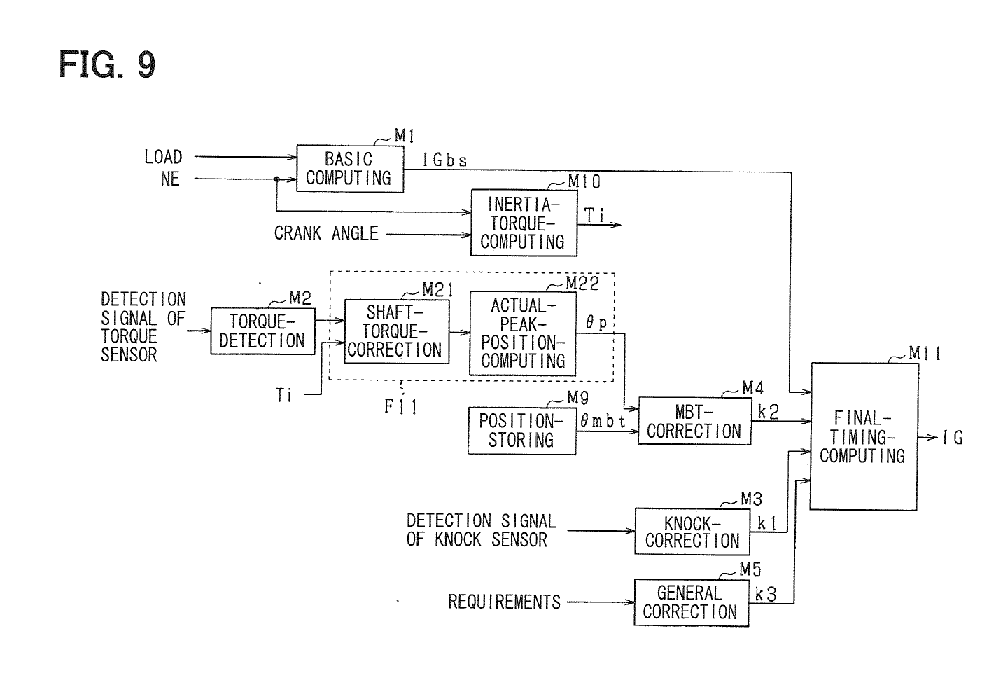

FIG. 9 is a block diagram showing a peak position computing portion.

As enclosed by a dashed line in FIG. 9, a peak position computing portion F11 includes a shaft-torque-correction portion M21 and an actual-peak-position-computing portion M22. The shaft-torque-correction portion M21 receives the shaft torque Trs from the portion M2 and the inertia torque Ti from the portion M10. Then, the portion M21 corrects the detected shaft torque Trs based on the inertia torque Ti. The detected shaft torque Trs is corrected by subtracting the inertia torque Ti from the shaft torque Trs.

The actual-peak-position-computing portion M22 receives the corrected shaft torque from the portion M21. Then, the portion M22 defines the rotational position at which the shaft torque is peak as the actual peak position θp. The MBT-correction portion M4 receives the actual peak position θp from the portion M22 and the MBT-position θmbt from the portion M9. Based on these, the portion M4 computes the MBT-correction quantity k2.

Although the actual peak position θp is computed based on the detected shaft torque Trs and the inertia torque Ti in the above embodiment, the detected peak position θp1 may be defined as the actual peak position θp without considering the inertia torque Ti.

In a case that the engine speed is greater than a specified threshold, the actual peak position θp is computed based on the detected shaft torque Trs and the inertia torque Ti. In a case that the engine speed is not greater than the threshold, the actual peak position θp is computed based on the detected shaft torque Trs without considering the inertia torque Ti. As shown in FIG. 4, when the engine speed is relatively low, the inertia torque Ti is small.

The MBT-position θmbt may be corrected based on an individual difference of the engine 10, a deterioration with age of the engine 10, an atmospheric temperature, an engine temperature, an EGR quantity and a compression ratio. Based on this corrected MBT-position θmbt and the actual peak position θp, the ignition timing may be controlled.

In the above embodiment, the actual peak position θp is computed based on the detected shaft torque Trs and the inertia torque Ti. According to the other embodiment, the previously stored MBT-position θmbt is corrected based on the inertia torque Ti, and the ignition timing control may be conducted based on the corrected MBT-position θmbt and the crank angle position at which the detected shaft torque Trs is peak.

What is claimed is:

1. A controller for an internal combustion engine having a fuel injector injecting a fuel and an igniter igniting the fuel with respect to each cylinder, the controller comprising:
a torque detecting portion detecting a shaft torque in a specified torque detection range defined for each cylinder, the shaft torque being generated due to a combustion of the fuel injected by the fuel injector and being applied to a crankshaft of the engine;
a peak position computing portion computing a crank angle position as an actual peak position at which a combustion torque becomes peak, based on the shaft torque detected by the torque detecting portion;
a position-storing portion storing a previously determined maximum torque position which corresponds to a crank angle position at which a combustion torque becomes peak; and
an ignition timing control portion controlling an ignition timing based on the actual peak position computed by the peak position computing portion and the maximum torque position stored in the position-storing portion.

2. A controller for an internal combustion engine according to claim 1, further comprising:
an inertia-torque-computing portion computing an inertia torque which is applied to the crankshaft based on a driving condition of the engine, wherein
the peak position computing portion computes the actual peak position based on the shaft torque detected by the torque detecting portion and the inertia torque computed by the inertia-torque-computing portion.

3. A controller for an internal combustion engine according to claim 2, wherein
the peak position computing portion includes:
a position-computing portion computing a crank angle position as a detected peak position at which the shaft torque detected by the torque detecting portion is peak; and
a position-correction portion correcting the detected peak position based on the inertia torque computed by the inertia-torque-computing portion in order to compute the actual peak position.

4. A controller for an internal combustion engine according to claim 2, wherein
the peak position computing portion includes:
a shaft-torque-correction portion correcting the detected shaft torque based on the inertia torque; and
an actual-peak-position-computing portion computing a crank angle position as the actual peak position at which the corrected shaft torque is peak.

5. A controller for an internal combustion engine according to claim 1, wherein
the torque detecting portion is a torque sensor which detects a strain angle of the crank shaft to detect the shaft torque.
